(19) United States
(12) Patent Application Publication
(10) Pub. No.: US 2008/0282504 A1
(43) Pub. Date: Nov. 20, 2008

(54) Device Comprising a Gripping Element

(75) Inventors: Thomas Baumeister, Bruchsal (DE); Bernhard Gotz, Zaisenhausen (DE); Jochen Herbolsheimer, Trostberg (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munich (DE)

(21) Appl. No.: 10/589,094

(22) PCT Filed: May 10, 2004
(86) PCT No.: PCT/EP04/04994

§ 371 Date: Aug. 9, 2006

(30) Foreign Application Priority Data
Feb. 11, 2004 (DE) 10 2004 006 764.3

(51) Int. Cl. E05B 1/00; F24C 15/02

(52) U.S. Cl. 16/412

(57) ABSTRACT

A device includes a gripping element of a device door. The gripping element is configured in such a manner that it can be displaced in relation to the device door when the door is displaced. The device improves operational comfort, in that the movement of the gripping element can be adapted to the movement of the hand of a user.

The invention relates to a device comprising a gripping element according to the preamble of claim 1.

Known from DE 102 08 496 U1 is a device comprising a handle element of an appliance door which is provided to move relative to the appliance door during a door movement of the appliance door. The device comprises a control gear which fixedly predetermines a movement of the handle element relative to the appliance door depending on the door movement of the appliance door.

It is particularly the object of the invention to provide a generic device with improved operating comfort. The object is achieved according to the invention by the features of claim 1 whilst advantageous embodiments and further developments of the invention can be deduced from the dependent claims.

The invention relates to a device comprising a gripping element of an appliance door which is provided to move relative to the appliance door during a door movement of the appliance door.

It is proposed that the movement of the gripping element can be adapted to the movement of the hand of a user. An appliance door which is particularly convenient to operate or a gripping element which is particularly convenient to operate can thus be achieved.

In this context, “provided” should be understood as “designed” and “equipped”. The movement of the gripping element should in particular be adaptable to different hand movements of different users. A gripping element is suitable for adapting to a hand movement of a user if it can be assumed that taking into account typical forces of a user, the gripping element is always in an ergonomically advantageous position during the hand movement of the user. In view of the high requirements for user comfort, use of the solution according to the invention in connection with doors of household appliances, and in particular in connection with horizontally pivoting doors of household appliances can be particularly beneficial.

A particularly flexibly adaptable device can be achieved if the gripping element is provided to be movably mounted at least largely independently of a position of the appliance door. A movement of the gripping element into impermissible positions which could impair comfort for example, can be avoided if the gripping element is provided to be mounted so that it can be moved between a first and a second position. In this case, the first and the second position can particularly advantageously be defined by stop elements which are used for supporting large user forces such as those which could occur when carrying the device using the gripping element, for example.

An undesirable resetting of the gripping element can be avoided if the device comprises a stabilising unit for stabilising the gripping element in at least one position.

A flexible choice of parking position can be achieved if the stabilising unit is provided for stabilising the gripping element in at least three positions.

As a result of the possibility for stabilising the gripping element in at least three positions, advantages can be achieved in particular if the gripping element is provided to be mounted on an appliance door which can be slid into a slide-in compartment. For example, the first position can be allocated to the closed appliance door, the third position can be allocated to an opened door which has not slid into the slide-in compartment and the second position can be allocated to the slid-in appliance door. In principle however, the use of the gripping element according to the invention is feasible in connection with any appliance which seems suitable to the person skilled in the art.

Particularly high user comfort can be achieved if the stabilising unit comprises at least one locating unit. In this connection, a locating unit should be designated as a unit which, starting from at least one configuration, produces and/or experiences an automatic locating movement of at least one component into a stable configuration. In principle, however, other stabilising units which appear appropriate to the person skilled in the art are also feasible, for example, magnetic or frictional stabilising units. Furthermore, the stabilising unit could also have an elastically deformable partial region holding the gripping element which can be deformed by means of the gripping element and which always stabilises the gripping element in the current position. In addition, the gripping element could also have elastically deformable per se and/or spring-loaded parts which adapt their position to a user's hand movement under the action of typical user forces.

At the same time, flexible adaptability or particularly finely graded adjustability can be achieved if the stabilising unit comprises at least one ribbed partial area. Ribbed should be designated here as a recess structure continued periodically in at least one direction.

If the stabilising unit is provided to stabilise the gripping element in a plurality of locating positions, it can be achieved that the user can always select a suitable locating position.

A movable mounting of the gripping element having a particularly simple design can be achieved if the gripping element is provided to be mounted on the appliance door so that it can pivot about a pivoting axis, wherein the gripping element can particularly follow an intuitive user hand movement if the pivoting axis of the gripping element runs at least substantially parallel to a pivoting axis of the appliance door.

The appliance door can be automatically reset if the device comprises means for releasing a stabilising unit in at least one position of the appliance door.

If the means is provided for releasing a locating connection during a closing movement of the appliance door, the gripping element can be conveniently reset into a rest position, in particular into the first position.

In addition, the device could advantageously comprise a locking device provided to lock the gripping element in a certain position.

If the device comprises a restoring means which is provided to automatically move the gripping element into a base position when the appliance door is closed, this can advantageously ensure that the gripping element is always in the base position when the appliance door is closed.

If the gripping element comprises at least two independent degrees of freedom of movement, the movement of the gripping element can be adapted particularly flexibly to the user's hand movement.

In addition it is proposed that in further embodiments of the invention, a sensor unit detects a movement characteristic of the gripping element and passes this on to a control unit and particularly advantageously to a programmable central processing unit which then comprises the detected movement and/or position as a characteristic for actuating another functional unit, for example, a lighting unit for lighting a cooker interior. In this context, a position, a time derivative of the position or a combination of the two should also be designated as a movement characteristic.

If the sensor unit comprises switching means which can be switched by means of the gripping element, a switching function can be conveniently integrated in the gripping element. In this case, the switching means can be switched by a movement of the gripping element in a second direction which is independent of a first direction in which the gripping element moves during an opening movement.

It is further proposed that the device comprises a sensor unit for sensing a user characteristic. Improved individual adaptability of the device to the user can thereby be achieved. A user characteristic can be given, for example, by a switching position of a switching means actuated by a user, by a body height, a hand temperature, a weight, a fingerprint or by any other characteristic which appears appropriate to the person skilled in the art. In an advantageous further development of the invention, for example, it is feasible that the sensor unit detects a weight and/or a body height of a user and if the weight and/or the body height falls below an applicable value, a signal is passed to a control unit which blocks the device comprising the appliance door and/or blocks any opening of the appliance door. This can prevent the appliance being used by unauthorised persons, for example, by children, and potential hazards can be eliminated. An effective child-proof function can be achieved in particular in connection with domestic cookers.

It is further possible to equip the locating device with magnetic locating forces which can be generated by permanent magnets and/or electromagnets. These locating forces can advantageously be adapted to different appliance types and/or different operating situations. An individual adaptation to a user who can be identified by means of the user characteristic would also be feasible.

The locating forces or the positions stabilised by the locating device can depend on the position of the appliance door. For example, certain positions of the gripping element could be destabilised in certain positions of the appliance door to achieve improved operating comfort. For this purpose, for example, a locating force produced by an electromagnet can be selectable or a locating elevation can be configured as variable by means of a gear unit. A particularly robust implementation of such a dependence can be achieved by mechanical coupling of a locating elevation of the locating device to the door movement of the appliance door.

In addition, configurations of the invention are feasible wherein the locating device is supported by a friction bearing during stabilisation of the gripping element.

A central processing unit could further be provided to detect a duration of a deflection of the gripping element from a stable position, for example, from the first position, the second position or the third position and use this as a characteristic. For example, it would be feasible to determine a temperature of a cooker comprising the appliance door depending on this duration. In this case, the cooker can particularly advantageously comprise a display element provided to display to a user a temperature assigned to the instantaneously detected duration.

It is further feasible that during the movement of the gripping element, for example, during the deflection of the gripping element from the first position, a switching means is automatically actuated which switches another functional unit directly or via a control unit.

For example, interior lighting of the cooker, a ventilation device or a lighting unit for lighting the gripping element and/or trademark emblem can be automatically switched on.

Such an automatic actuation of another functional unit would also be feasible if a proximity and/or contact sensor is provided to detect an approach and/or contact of a user's hand on a component of the device and to produce a switching signal dependent thereon.

A particularly convenient operation of the appliance door can be achieved if the device comprises a damping means for damping a movement of the gripping element. In a particularly cost-effective embodiment, the damping means is embodied as a friction element.

Further advantages are obtained from the following description of the drawings. The drawings show exemplary embodiments of the invention. The drawings, the description and the claims contain numerous features in combination. The person skilled in the art will appropriately consider the features individually and combine them to give appropriate further combinations.

In the figures:

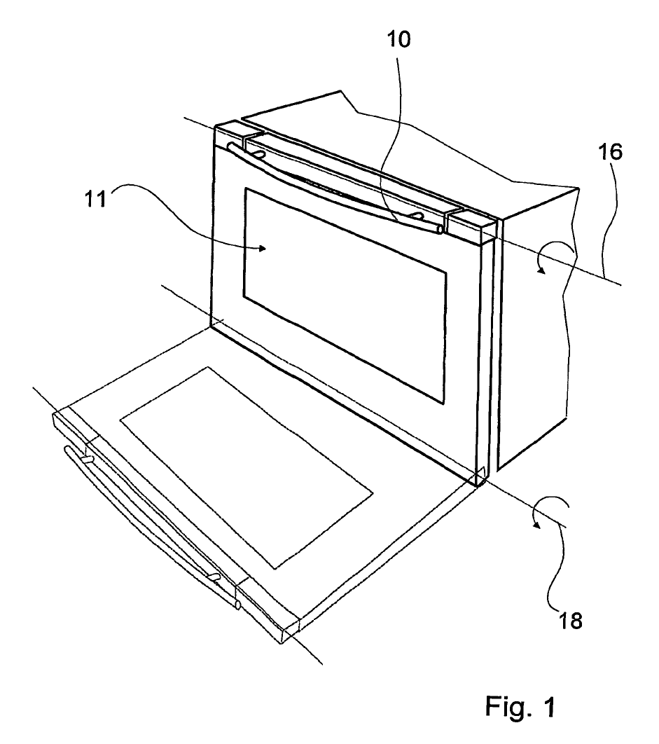

FIG. 1 shows a cooker provided with an appliance door having a pivotally mounted gripping element,

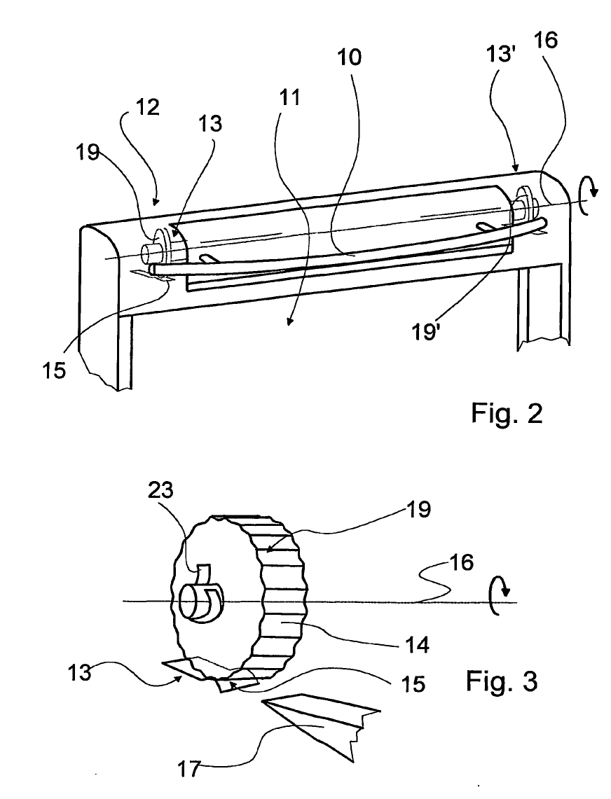

FIG. 2 is a section of the cooker from FIG. 1 with the gripping element,

FIG. 3 is a locating device of the gripping element from FIGS. 1 and 3,

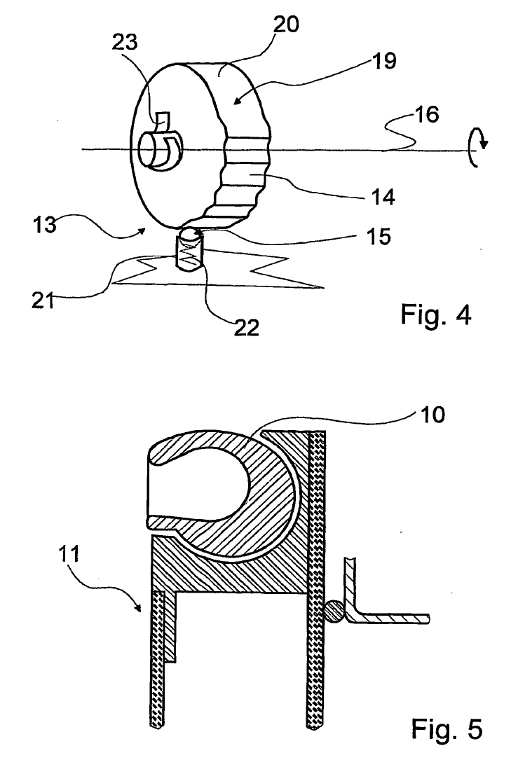

FIG. 4 is an alternative locating device for a gripping element,

FIG. 5 is a sectional view of an appliance door with a gripping element in a further embodiment of the invention,

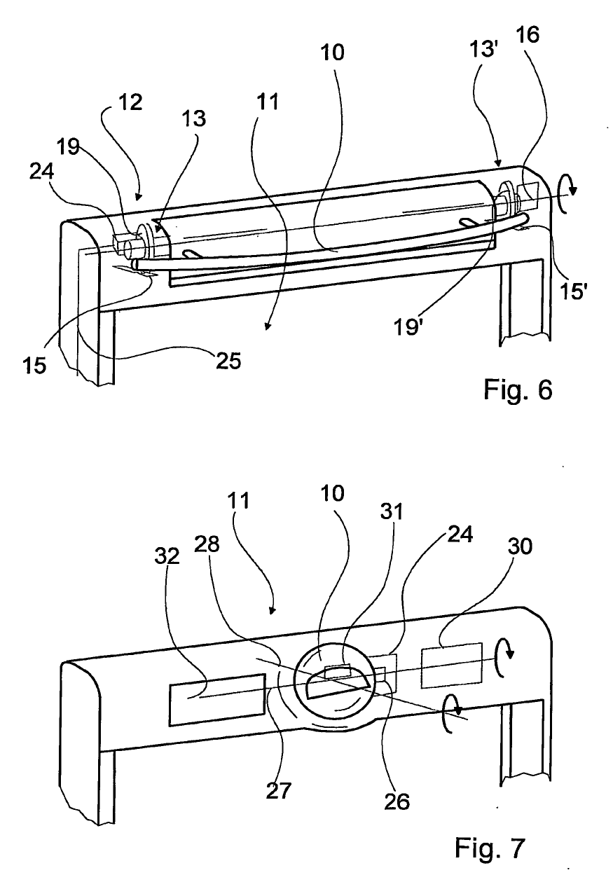

FIG. 6 is an alternative embodiment with a sensor unit, a drive element and a damping means and

FIG. 7 is a further alternative device provided with a gripping element comprising two independent degrees of freedom of movement.

FIG. 1 shows a cooker with a double-walled appliance door 11 which is mounted on the cooker so that it can pivot about a horizontal pivoting axis 18 and is provided to close a cooking chamber of the cooker. In this case, the appliance door 11 is vertically aligned in a first position and horizontally aligned in an opened second position shown by the dashed lines in FIG. 1. At an edge defining the top of the appliance door 11 in the first position, the appliance door 11 comprises a gripping element 10 which is pivotally mounted about a horizontal pivoting axis 16 relative to the appliance door 11 and relative to a body of the cooker, said axis running parallel to the pivoting axis 18 of the appliance door 11 which is located in the area of an edge of the appliance door 11 opposite to the gripping element 10.

The gripping element 10 comprises a slightly bent handle bar which is screwed by means of spacer sleeves to a bearing device pivotally mounted on a body of the appliance door 11. The bearing device comprises a roller-shaped bearing element made of plastic. In a parking position of the gripping element 10 the spacer sleeves project vertically out from the plane of the appliance door 11.

If a user grips the handle bar of the gripping element 10, in order to open the appliance door 11, starting from the first position, for example, the gripping element 10 pivots against a stabilising force produced by a stabilising unit 12 about the pivoting axis 16 relative to the appliance door 11 which is at the same time pivoted by the user about the pivoting axis 18. The stabilising force is designed to that the movement of the gripping element 10 is always matched to a user's hand movement. In this case, the gripping element 10 is mounted so that it can move independently of a position of the appliance door 11 about the pivoting axis 16 between a first position, the parking position, and a second position shown in the dashed lines in FIG. 1. In the second position, the spacer sleeves and with them the entire gripping element 10 are in alignment with a door plane of the appliance door 11 so that in the open position the user can also see the gripping element 10 even when he looks from above onto an inner side of the appliance door 11 held horizontally in the second position.

The stabilising unit 12 comprises two locating units 13, 13′ each comprising a wheel 19, 19′ fluted in an outer region and a locating element 15, 15′ embodied as a leaf spring. Of the mirror-symmetrical locating units 13, 13′, only the locating unit 13 will be described hereinafter (FIG. 3). The locating element 15 affixed to the body of the appliance door 11 comprises a locating lug embodied as a kink which engages in indentations of a fluted partial area 14. The wheel 19 is moulded onto axial formations of the mounting body and is aligned coaxially with the pivoting axis 16.

If a user pivots the gripping element 10 about the pivoting axis, the locating lug of the locating element 15 is successively displaced from one indentation in the fluted partial area 14 of the wheel 19 rotating about the pivoting axis 16 into the next in order to engage therein. The locating element 15 embodied as a leaf spring is mounted under a slight pre-stress and is therefore always spring-loaded when sweeping over the fluted partial area 14. In this case, the locating force is sufficiently strong to stabilise the gripping element 10 in any third position between the first and the second position in which the locating element 15 engages in an indentation of the wheel 19. These positions or indentations are distributed isotropically over an angular range of about 70° in the fluted partial area 14 of the wheel 19. The stabilising unit 12 is therefore provided to stabilise the gripping element 10 in a plurality of locating positions.

Furthermore, the strength of the locating force is matched to a force which must be expended by the user to open the appliance door 11 in order to avoid the gripping element 10 turning directly into the first or into the second position during pulling and can effectively follow the user's hand movement. This force is produced by a spring mechanism integrated in the hinge units of the appliance door 11, not shown, and by the weight of the appliance door 11. The locating force is therefore matched to the spring mechanism.

Embodiments of the invention are feasible wherein, as a result of the different depth of the indentations, the locating unit 13 produces a spring force which depends on the position of the gripping element 10 relative to the appliance door 11.

Embodiments of the invention are feasible wherein a movement of the locating element 15 generates a sound by means of a sound-generating means, this being optimised so that a user is imparted a sense of the gripping element 10 being of particularly high quality. This could be achieved for example by a specific manipulation of resonance properties of the wheel 19.

The body of the cooker has wedge-shaped means 17 for releasing the stabilising unit 12 in positions of the appliance door 11 in which the appliance door 11 is almost closed. During a closing movement the means 17 fixedly connected to the body of the cooker engages through an opening into an interior space of the appliance door 11 and between the locating element 15 and the wheel 19. The locating element 15 embodied as a leaf spring is displaced by the means 17 during closure of the appliance door so that the locating lug of the locating element 15 is released from the indentations of the fluted partial area 14. The stabilising unit 12 is released during a closing movement of the appliance door 11 since the means pushes between the locating element 15 and the wheel 19, thus unlocking the locating connection of the locating unit 13.

The axial formations of the bearing body of the gripping element 10 are equipped with a slide-in slot to receive a restoring means 23 embodied as a spiral spring which is provided to automatically move the gripping element 10 into a base position when the appliance door 11 is closed or almost closed. The restoring means 23 is inserted with its first end in the slide-in slot of the bearing body of the gripping element 10, embraces the axial formations circumferentially and is provided to be clamped by a second end to a body of the appliance door 11 under pre-tension. A wrapping direction of the restoring means 23 is selected so that the restoring means 23 coils together when a user moves the gripping element 10 from the first position into the second position. In this case, the restoring means 23 produces a torque in the direction of the first position which is intercepted by the stabilising unit 12 when the locating connection of the locating element 15 is closed.

When the locating connection of the locating element 15 is released by the means 17, the torque exerted by the restoring means 23 on the gripping element 10 puts the gripping element 10 into the first position.

However, embodiments of the invention are also feasible wherein the gripping element 10 automatically drops into the base position merely as a result of gravity and wherein a restoring means 23 can advantageously be dispensed with. For this purpose, the gripping element 10 can be fitted with integrated counterweights. In the exemplary embodiment shown in FIGS. 1-3, for example, the restoring means 23 can be dispensed with if the gripping strip of the gripping element 10 is made of metal and thereby produces a sufficient counterweight to allow it to be automatically restored into the first position when the appliance door 11 is closed, in which position the gripping element 10 is then fixed by a stop.

FIGS. 4-7 show further embodiments of the invention. In the description of the exemplary embodiments in FIGS. 4-7, differences from the exemplary embodiment in FIGS. 1-3 are substantially discussed. Reference can be made to the exemplary embodiments in FIGS. 1-3 with regard to features which remain the same. In this case, similar features of the various exemplary embodiments are designated by the same reference numerals.

FIG. 4 shows an alternative stabilising unit 12. In an area 20 of a wheel 19 which accounts for about 20°, and which is swept by a locating lug of a locating element 15, when the gripping element 10 approaches the first position, the wheel 19 has a slightly reduced radius and the fluting stops so that the stabilising unit 12 transfers no stabilising force to the gripping element 10.

A restoring means 23 is provided to move the gripping element 10 automatically into the base position when the appliance door 11 is closed or nearly closed and specifically into the first position when the gripping element 10 is located in a position in which the locating lug of the locating element 15 comes to lie in the region 20. Positions in which the locating lug of the locating element 15 come to lie in the fluted area 14 cannot arise when the appliance door 17 is closed otherwise the gripping element 10 hits against the lining of the cooker not shown here.

The stabilising unit 12 shown in FIG. 4 comprises an alternative locating element 15 which is embodied as a ball. The locating element 15 is mounted axially displaceably in a tubular bearing unit 21 moulded on the body of the appliance door 11. A radius of the bearing unit 21 is tapered in an end region facing the wheel 19 so that the locating element 15 is held secured against loss. A spring element 22 loads the locating element 15 and produces a locating force directed towards the wheel 19.

Instead of a gripping strip, the exemplary embodiment shown in FIG. 5 comprises a recess in the bearing body of a gripping element 10 in which a user can grip with his fingers. As a result of the smaller lever, relevant locating devices can be designed with weaker locating forces without needing to accept loss of comfort.

In the exemplary embodiment shown in FIG. 6, a sensor unit 24 in the area of a first locating unit 13 senses a position and/or movement of a gripping element 10. A switching unit not shown here of a cooker comprising the device can pick up and process a signal of the sensor unit 24 by means of a sensor lead 25. If the sensor unit 24 senses a movement of the gripping element 10, the switching unit switches on an interior light of the cooker if this was switched off. If the switching unit receives no signal over an applicable period of a few minutes and if the cooker is unheated at the same time, the switching unit automatically switches off the interior lighting. Other types of use of the signal from the sensor unit 24 which appear appropriate to the person skilled in the art are also feasible, wherein the appliance door 11 shown can be used flexibly in connection with differently configured cookers or switching, control and/or regulating units. In the area of the second locating unit 13′ the device has a damping element 26 for damping a movement of the gripping element 10. The damping element 26 is embodied as a dynamo so that it picks up a pivoting movement of the gripping element 10 and generates an induced voltage in armature windings of the damping element 26. At the same time, the damping element 26 is a driving element for driving the movement of the gripping element 10 which can be controlled by a control unit of the cooker. When the cooker is switched on, the control unit delivers an electric current to the damping element 26 so that this moves automatically into a position of readiness.

FIG. 7 shows an upper section of an appliance door 11 of a cooker which comprises a gripping element 10 having two degrees of freedom of movement 27, 28 embodied as pivoting axes. The gripping element 10 is substantially spherical and comprises a recess 29. A sensor unit 24 detects a position of the gripping element 10 and comprises a damping element 26 for damping a movement of the gripping element 10, its function being the same as that of an eddy current brake. The sensor unit 24 detect a speed averaged over a few seconds, transmits this to a control unit 30 integrated in the appliance door 11 which is embodied as a programmable central processing unit. The control unit 30 supplies the damping element 26 depending on the detected speed so that a rapid movement of the gripping element results in strong damping after a few seconds. The sensor unit 24 thereby detects a user characteristic, namely the speed which correlates with the nervousness of the user and causes the damping to be adapted individually to the user by means of the control unit 30.

The sensor unit 24 further comprises a switching means 31 embodied as a pushbutton whereby the user can trigger a switching signal by pressing the gripping element 10 in the direction of the door plane of the appliance door 11 and the control unit 30 processes this signal.

In an upper lateral area, the appliance door 11 comprises a display unit 32 provided to display user information. For example, a current operating mode of the cooker can be displayed. In an advantageous embodiment of the invention, the user can trigger the switching signal of the switching means 31 by pressing the gripping element 10 when the appliance door 11 is closed and thereby make a selection from a selection menu which is displayed by the control unit 30 on the display element 32 and which can be scrolled by turning the gripping element 10. In this case, an operating mode of the cooker can advantageously by determined by a hierarchical menu structure. By selecting specific menu items, it is possible to activate operating modes wherein an operating parameter, for example, a temperature of the cooker can be adjusted by turning the gripping element 10, wherein an actual setting appears on the display element 32 and wherein the actual setting can be confirmed and/or stored by triggering a switching means 31.

### REFERENCE LIST

10 Gripping element
11 Appliance door
12 Stabilising unit
13 Locating unit
14 Partial region
15 Locating element
16 Pivoting axis
17 Means
18 Pivoting axis
19 Wheel
20 Region
21 Bearing unit
22 Spring element
23 Restoring means
24 Sensor unit
25 Sensor lead
26 Damping element
27 Degree of freedom of movement
28 Degree of freedom of movement
29 Recess
30 Control unit
31 Switching means
32 Display element

1-20. (canceled)

21. A device comprising:
a gripping element of an appliance door movable relative to the appliance door during a door movement of the appliance door, the gripping element adapting its movement to the movement of the hand of a user.

22. The device according to claim 21, wherein the gripping element is movably mounted at least largely independently of a position of the appliance door.

23. The device according to claim 21 and further comprising a stabilizing unit for stabilizing the gripping element in at least one position.

24. The device according to claim 23, wherein the stabilizing unit stabilizes the gripping element in at least three positions.

25. The device according to claim 23, wherein the stabilizing unit includes at least one locating unit.

26. The device according to claim 25, wherein the locating unit includes at least one ribbed partial area.

27. The device according to claim 23, wherein the stabilizing unit includes a spring-loaded locating element.

28. The device according to claim 23, wherein the stabilizing unit stabilizes the gripping element in a plurality of locating positions.

29. The device according to claim 21, wherein the gripping element is mountable on the appliance door so that it can pivot about a pivoting axis.

30. The device according to claim 29, wherein the pivoting axis runs at least substantially parallel to a pivoting axis of the appliance door.

31. The device according to claim 23 and further comprising means for releasing the stabilizing unit in at least one position of the appliance door.

32. The device according to claim 21 and further comprising means for releasing a locating connection during a closing movement of the appliance door.

33. The device according to claim 21 and further comprising a restoring means to automatically move the gripping element into a base position when the appliance door is closed.

34. The device according to claim 21, wherein the gripping element comprises at least two independent degrees of freedom of movement.

35. The device according to claim 21 and further comprising a sensor unit for sensing a movement characteristic of the gripping element.

36. The device according to claim 35, wherein the sensor unit comprises switching means which can be switched by means of the gripping element.

37. The device according to claim 21 and further comprising a sensor unit for sensing a user characteristic.

38. The device according to claim 35 and further comprising a control unit provided for processing a signal of the sensor unit.

39. The device according to claim 21 and further comprising a drive element for driving the movement of the gripping element.

40. The device according to claim 21 and further comprising a damping element for damping a movement of the gripping element.
